(19) United States
(12) Patent Application Publication
(10) Pub. No.: US 2014/0328546 A1
(43) Pub. Date: Nov. 6, 2014

(54) SIGNAL PROCESSING METHOD AND APPARATUS FOR IMPLEMENTING SAID METHOD

(71) Applicant: Elettra-Sincrotrone Trieste S.C.P.A., Basovizza (IT)

(72) Inventors: Georgios Kourousias, Trieste (IT); Alessio Curri, Trieste (IT); Roberto Pugliese, Duino (IT)

(73) Assignee: Elettra-Sincrotrone Trieste S.C.P.A., Basovizza (IT)

(21) Appl. No.: 14/360,835

(22) PCT Filed: Nov. 28, 2012
(86) PCT No.: PCT/EP2012/073808

§ 371 Date: May 27, 2014

(30) Foreign Application Priority Data
Nov. 29, 2011 (IT) PD2011A000376

(51) Int. Cl. H04N 19/91; H04N 19/86

(52) U.S. Cl. CPC H04N 19/00987; H04N 19/00909
USPC 382/239

(57) ABSTRACT

A method (1) of processing signals by means of rescaling, comprising the steps of: —downscaling (10) an initial signal (11), in accordance with a predetermined downscaling factor (Df) to obtain a downscaled signal (12), —upscaling (20), the downscaled signal (12) to obtain an upscaled signal (13) having the same dimensions as said initial signal (11), —comparing (30) the initial signal (11) and the upscaled signal (13) to calculate a comparison parameter, —if said comparison parameter is within a previously defined range, decreasing (50) the downscaling factor (Df) and repeating the steps of downscaling (10), upscaling (20) and comparison (30), —if said comparison parameter is outside the previously defined range, encoding (40) an encoded signal (14) as a function of the downscaled signal (12).

### CROSS REFERENCE TO RELATED APPLICATIONS

The present application claims priority to PCT International Application No. PCT/EP2012/073808 filed on Nov. 28, 2012, which application claims priority to Italian Patent Application No. PD2011A000376 filed Nov. 29, 2011, the entirety of the disclosures of which are expressly incorporated herein by reference.

### STATEMENT RE: FEDERALLY SPONSORED RESEARCH/DEVELOPMENT

Not Applicable.

### BACKGROUND OF THE INVENTION

1. Field of the Invention

The present invention relates to a signal processing method and to apparatus usable for implementing said method. The present invention is especially, although not exclusively, practicable for processing two-dimensional static images, or video films.

2. Prior Art

A plurality of processing methods that can be used for the encoding and/or compression of digital signals are already known within this technical field. These methods operate within the frequency domain such as, for example, those based on implementation of the Discrete Cosine Transform (DCT) function, or in the time domain, such as those based on implementation of the Wavelet Transform function. In particular, for image encoding, the Discrete Cosine Transform is used in the JPEG compression method, whereas the Wavelet Transform is used in the JPEG2000 compression method.

The encoded signals generated with the use of the methods cited above are then recorded in electronic mass-memory backup units. Notwithstanding that changes in techniques for miniaturising electronic components are enabling an ever greater number of data to be recorded within very small volumes; in many sectors there is still a perceived necessity to reduce to a minimum the size of the data to be recorded, obviously without significant deterioration in the content of the data itself. Within the image encoding field one might, for example, consider the fact that devices of ever decreasing size, for example mobile phones, compact cameras or small video cameras, are required to be able to record an ever greater number of images.

In general, whatever the type of signal and recording device, optimum managing of the dimensions of the encoded signal enables efficient and economical handling of the storage space occupied by the encoded signal.

Said optimisation is not always obtainable with the above-mentioned known processing methods.

### SUMMARY OF THE INVENTION

The aim of the present invention is to provide a new method of signal processing, characterised by good cost-effectiveness and calculating efficiency, which is capable of obviating all the drawbacks mentioned with reference to the cited known art, by providing a method for encoding and/or compressing digital signals which is capable of minimising the dimensions of the encoded and/or compressed signal and/or without compromising its quality characteristics.

Another aim is to define a new method for processing static images or video film.

A further aim is to make available a device usable for processing signals in accordance with the above-mentioned method.

According to the invention, the above-mentioned technical problem is resolved by means of a signal-processing method having the features mentioned in independent claim 1 and by means of a device having the features mentioned in independent claim 8.

In particular, in a first aspect the invention relates to a method for processing signals by means of rescaling, comprising the steps of downscaling an initial signal according to a predetermined downscaling factor in order to obtain a downscaled signal; upscaling of said downscaled signal to obtain an upscaled signal having the same dimensions as said initial signal; comparing said initial signal and said upscaled signal to calculate a comparison parameter; if said comparison parameter is within a previously defined range, decreasing said downscaling factor and repeating said downscaling, upscaling and comparing steps; if said comparison parameter is outside said previously defined range, encoding an encoded signal as a function of said downscaled signal.

The present invention enables a processing method to be obtained, which operates within the space domain by means of rescaling of the signal. In methods of signal processing which operate within the frequency or time domain, the signal is processed by encoding the data relating to a defined space. In the imaging field, for example, this space is made up of the number of pixels which define the image itself. In general, the present method processes the signal by rescaling this space. In the imaging field, this means that the method of the present invention converts an initial image into an encoded image, by modifying the number of pixels defining the image. However, the content of each pixel of the encoded image is the same as that of one or more pixels of the starting image.

The method defined above is characterised by iteration of a cycle comprising the steps of downscaling, upscaling and comparison until a predetermined value of the comparison parameter is reached. The comparison parameter is generated at each iteration of the above-mentioned cycle as a function of the upscaled signal and of the initial signal. The cycle is interrupted as soon as the upscaled signal differs significantly from the initial signal, thus indicating that further iterations of the cycle would involve an excessive deterioration of the data contained in the initial signal. Only after the cycle is interrupted the method generates the encoded signal. In this way, the present invention allows for optimally downscaling the signal, limiting the deterioration of the data to a threshold which is considered acceptable. This enables optimisation of storage space and of data transmission.

Other advantages of the present invention are obtained by means of a signal processing method according to the dependent claims, as better explained in the description below. In particular, the present method provides for generation of the encoded signal by means of recording the downscaled signal and the related downscaling factor, and/or its reciprocal upscaling factor, and optionally the type of downscaling algorithm used. In way, the encoded signal contains all the data necessary for its decoding.

The method described above is in particular, although not exclusively, applicable to the processing of signals composed of two-dimensional images, since in this case the data subject to encoding relates to a visual representation of a two-dimensional space, to which the rescaling according to the present invention is applied.

In a second aspect, the invention relates to a signal-processing device comprising a memory in which are stored software encoding instructions adapted to execute the steps of the signal processing method described above, when said programme is executed in said device for signal processing. By comparison with known signal-processing devices, such a device achieves the same advantages as mentioned above, with reference to the method of the present invention. In the field of image encoding, such a device, in possible embodiments thereof, is a photo camera or a video camera.

### BRIEF DESCRIPTION OF THE DRAWINGS

Further features and advantages of the present invention will emerge more clearly from the following detailed description of a preferred, albeit non-exclusive, embodiment thereof which is illustrated, by way of a non-limiting indication, with reference to the attached drawings, wherein:

FIGS. 1, 2 and 3 are diagrammatic representations of signals to which the method according to the present invention is applicable,

FIG. 4 is a simplified flow diagram of the method according to the present invention,

FIG. 5 is a detailed representation of the flow diagram in FIG. 4,

FIG. 6 is a graph representing a comparison parameter used when implementing the method of the present invention,

FIG. 7 is a schematic representation of another signal to which the method according to the present invention is applicable,

FIG. 8 is a simplified representation of a device comprising image-processing means according to the present invention.

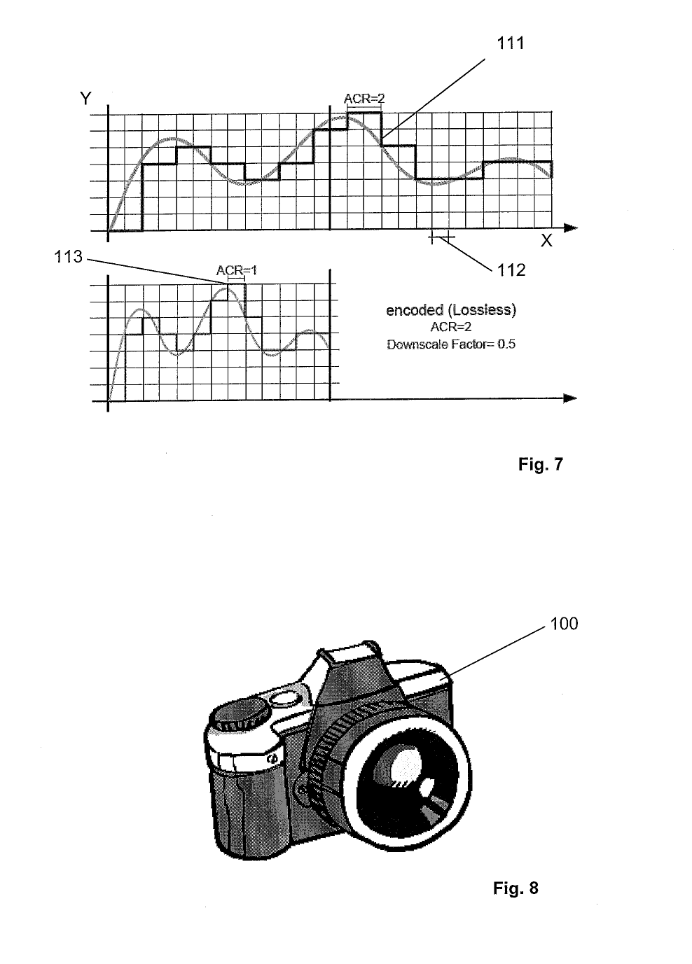

### DETAILED DESCRIPTION OF THE INVENTION

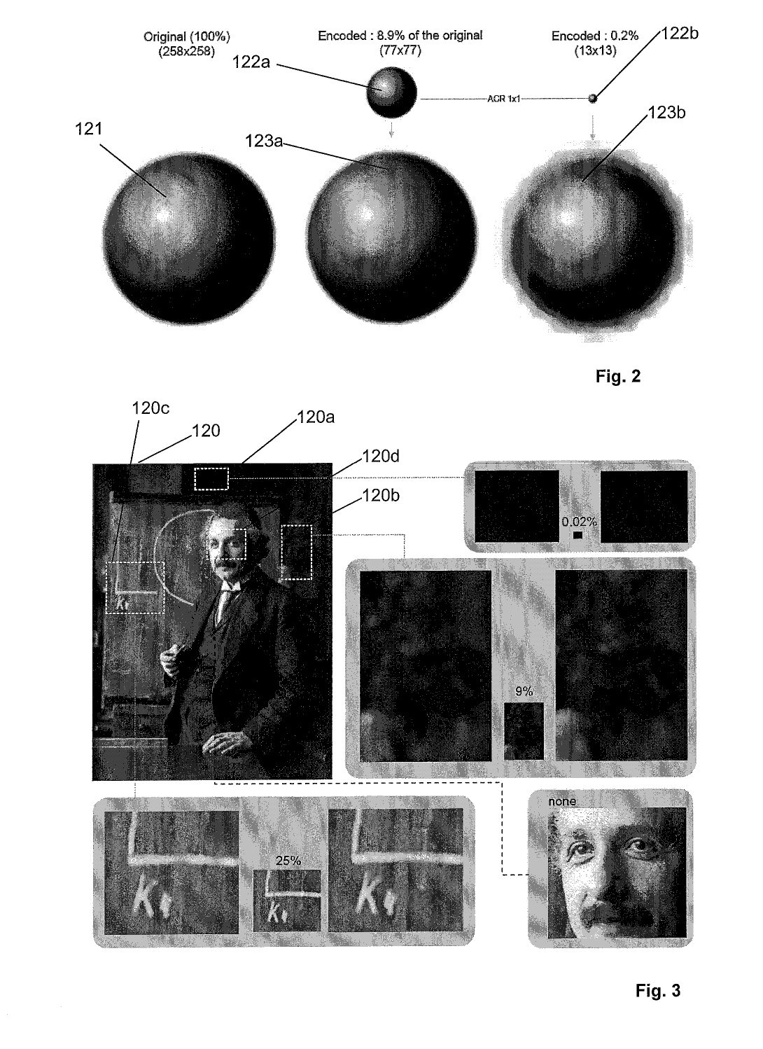

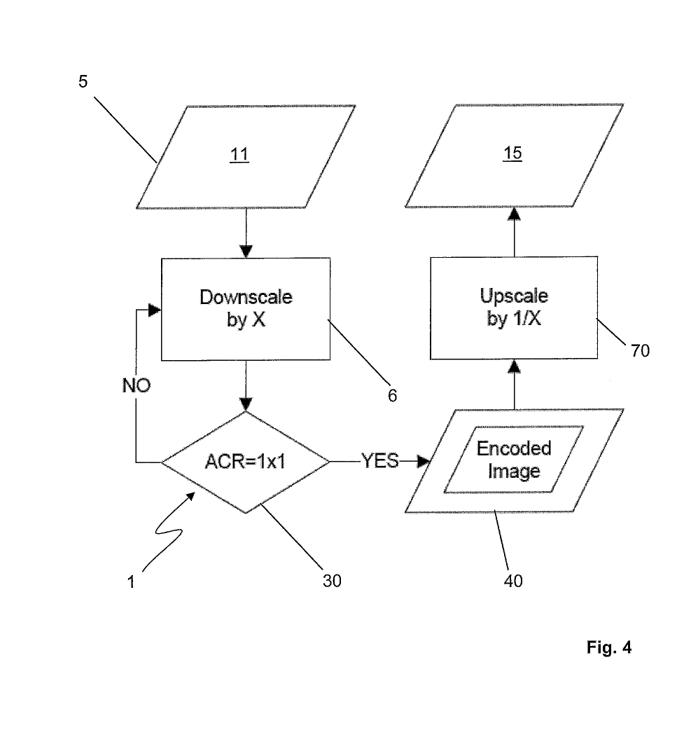

With reference to FIGS. 4 and 5 attached, a method of signal processing by means of a rescaling procedure is indicated overall by reference numeral 1. The method 1 is generically applicable to an initial signal 11 of any type.

The initial signal 11 is in particular, although not exclusively, composed of static two-dimensional images or video films. In the description below, reference will be predominantly made to signals composed of static two-dimensional images, while always intending, even when not expressly stated, that method 1 is applicable to signals of any type.

Method 1 comprises a first initial step 5 of loading the initial signal 11, followed by a subsequent phase 10 of downscaling the initial signal 11 according to a predetermined downscaling factor, Df, so as to obtain a downscaled signal 12. In an embodiment of the present invention, the initial signal 11 and the downscaled signal 12 are, respectively, an initial two-dimensional image and a downscaled two-dimensional image having respective dimensions, expressed as pairs of numbers of pixels along the horizontal and vertical directions, equal to w1×h1 and w2×h2, respectively. In this embodiment, the downscaling factor Df is defined as the relationship between the number of pixels on the horizontal or vertical dimension of the downscaled image and the number of pixels on the same dimensions of the initial image:

Df=w2/w1=h2/h1. (A)

The downscaling is assumed to be the same for both dimensions of the initial image.

Alternatively, the downscaling factor Df is defined as the relationship between the number of pixels in the downscaled image and the number of pixels in the initial image:

Df=(w2×h2)/(w1×h1). (B)

For both equations A, B, the downscaling factor Df may be expressed as a percentage value.

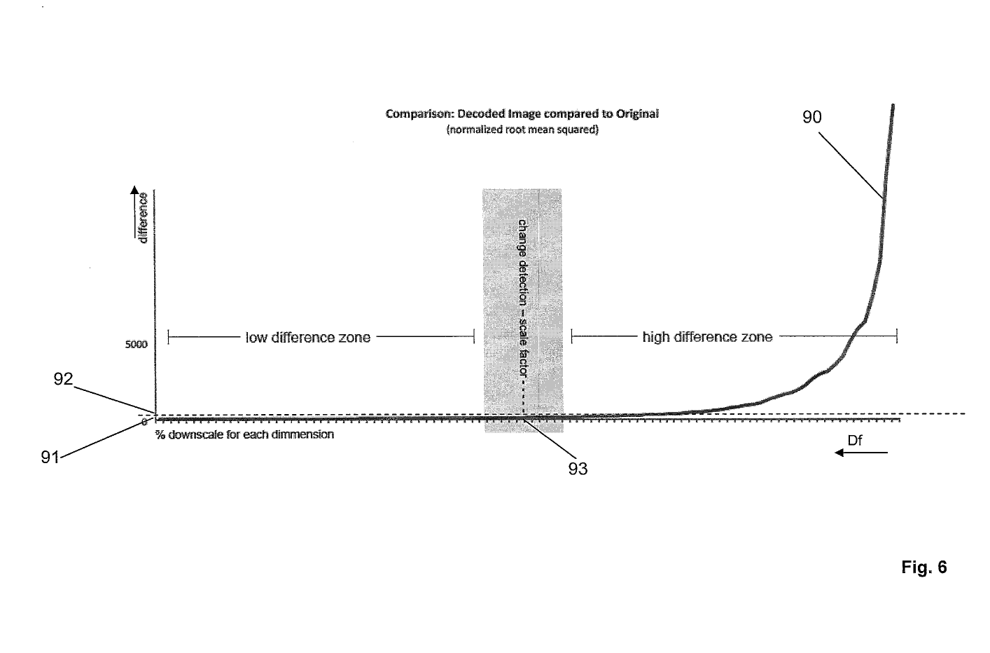

In the embodiments where the initial signal 11 is a digital signal, the data contained therein may be represented in a space subdivided into a finite plurality of elementary spatial units. In the case of two-dimensional images, these elementary units are the pixels of the image. In the case of the digital signal 111 in FIG. 7, a dependent variable Y, expressed as a function of an independent variable X, according to an equation of the type:

Y=F(ΔX),

may be represented on a two-dimensional graph, wherein the abscissas represent the independent variable, and the elementary spatial unit is comprised of the elementary interval 112. In an embodiment of the invention, the independent variable is time, and the elementary spatial unit is the elementary time interval used when acquiring or sampling the signal.

In general, however, method 1 is also applicable to analogue signals provided that the analogue signals are digitalised by means of digitalisation step (not represented in the diagram of FIG. 5) preceding the loading step 5 or, alternatively, included between loading step 5 and downscaling step 10.

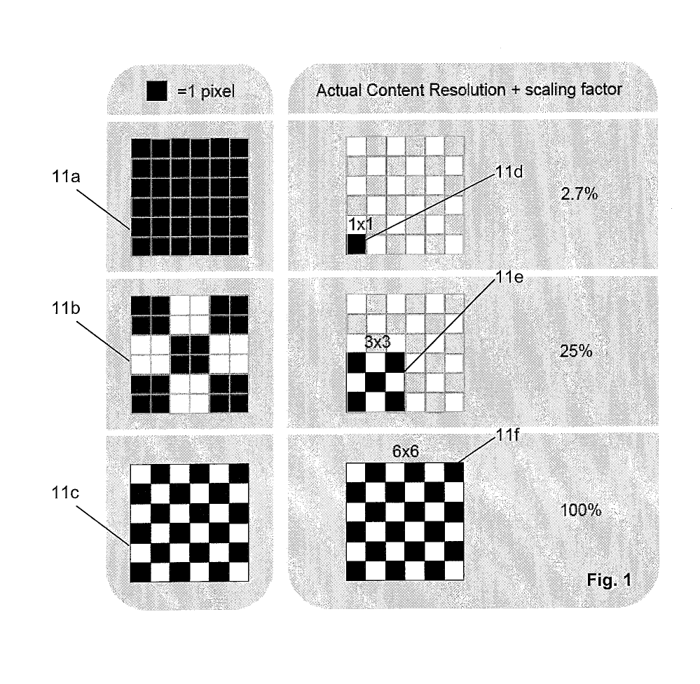

In general, it is possible that a single datum contained in the initial signal 11, 111 is recorded in a plurality of elementary spaces adjacent to one another. In the example in FIG. 1, three two-dimensional images 11a,b,c of dimensions 6×6 (36 pixels overall for each of the images 11a,b,c) are shown. In image 11a, the same visual datum is present in all the 36 pixels, and is therefore scalable in the image 11d comprising one single pixel, without loss of visual data content. In this case, the calculated scale factor according to equation B is equal to 1/36 (2.7%). Image 11b is comprises six groups of 4 pixels, the pixels of each group showing the same visual datum. Therefore, image 11b is scalable in image 11e by converting each group of 4 pixels into a single pixel, again without loss of visual data content. In this case, the calculated scale factor according to equation B is equal to ¼ (25%). In image 11c, each pixel corresponds to a visual datum which is different from that of the adjacent pixels in the horizontal or vertical direction, and consequently the scaled image 11f is equal to the initial image 11c, with a scale factor equal to 1 (100%). In the case of image 11c, downscaling using a scale factor Df<1 is applicable only by accepting a loss of visual data content. In signal 111, each datum is recorded in respective pairs of adjacent elementary ranges 112. Signal 111 is therefore scalable into signal 113, using scale factor 0.5 (50%), calculated according to equation A, applied only to the horizontal dimension, i.e. to the abscissa X of signal 111. In the case of complex signals, downscaling step 10 is preferably applied to portions of the signal 11 in such a way that each portion is scaled according to a respective optimal value of the downscaling factor Df. For example, in photographic image 120 (FIG. 3), the four scalable portions 120a-d are identifiable without loss of visual data content or with negligible loss, according to increasing values (0.02%; 9%, 25% and 100%) of the downscaling factor Df.

In all cases, the purpose of the downscaling step 10 is to obtain a downscaled signal 12, for which each elementary spatial unit (pixel, in the case where the initial signal 11 is an image) is used to contain a respective datum, initially contained in the initial signal 11, and distinct from all the data contained in the adjacent elementary spatial units of the downscaled signal 12. Distinct data contained in the initial signal 11, may be represented in a unique elementary spatial unit of the downscaled signal 12, whenever such data do not differ from one another significantly, according to criteria which will be more clearly specified in what follows.

In the downscaling step 10, a first rescaling algorithm, which is per se conventional and known-in-the-art, is used, for example a linear, bicubic, Lanczos or other known algorithm.

The downscaling step 10 is followed by a step 60 of calculating an upscaling factor Uf which, in the case of signals comprised of images, is defined as the reciprocal of the downscaling factor Df:

Uf=w1/w2=h1/h2. (A1)

Uf=(w1×h1)/(w2×h2). (B1)

Step 60 is followed by a subsequent step 20 of upscaling the downscaled signal 12 according to the upscaling factor Uf, to obtain an upscaled signal 13 having the same dimensions as said initial signal 11. In the upscaling step 20, a second upscaling algorithm, which is per se conventional and known-in-the-art, is used, for example a linear, bicubic, Lanczos or other known algorithm. In different embodiments of the present invention, the first and second rescaling algorithms are equal to each other or different from one another.

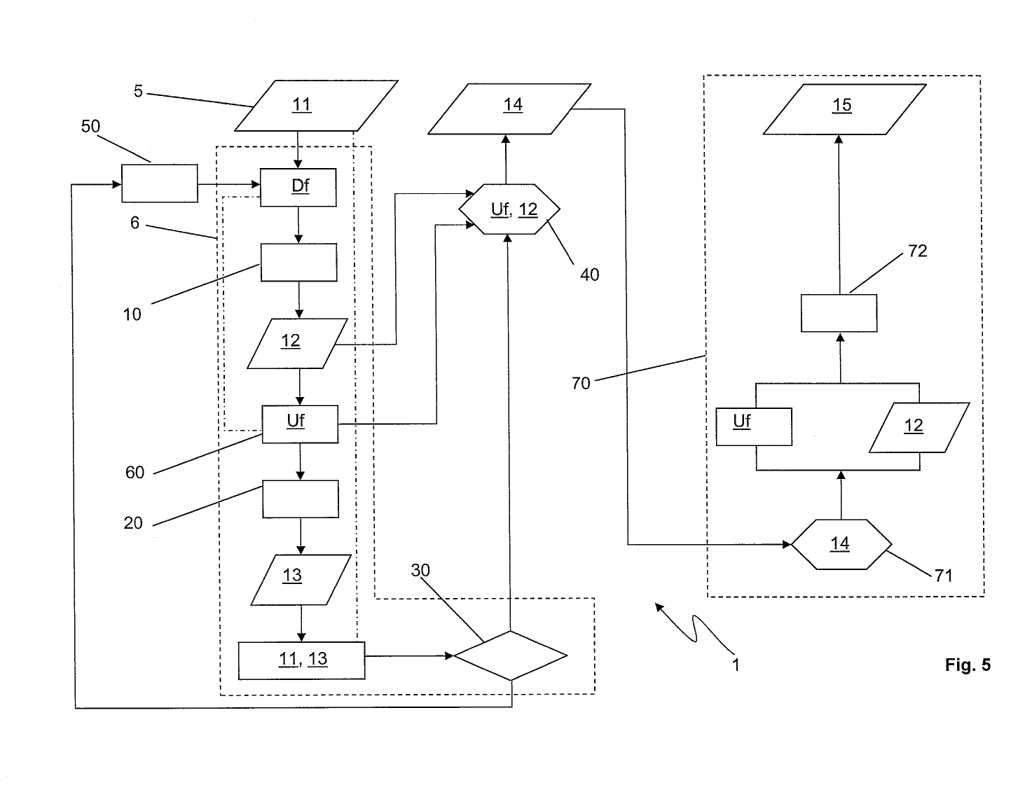

Step 20 is followed by subsequent step 30 of comparing the initial signal 11 and the upscaled signal 13 for the purpose of calculating a comparison parameter 90 (FIG. 6), which expresses a difference between the upscaled signal 13 and the initial signal 11. This difference is calculated by means of algorithms that are conventional and known per se, for example by means of the algorithms named “Normalised Root Mean Square” (FIG. 6), “Peak Signal-to-Noise Ratio” and “Normalised Mean Error”.

Steps 10, 20, 60 and 30 constitute a calculation cycle 6 which may be performed iteratively. Number of iterations depends on the comparison performed in step 30. If, during the comparison step 30, the upscaled signal 13 is identified as being similar to the initial signal 11, method 1 continues with the successive step 50 of decreasing the downscaling factor Df. After executing step 50, method 1 continues by iterating cycle 6, i.e. by repeating steps 10, 20, 60 and 30, in succession.

To identify the condition of similarity between the upscaled signal 13 and the initial signal 11, during comparison step 30 the comparison parameter 90 is compared with a previously defined range of values 91 that are considered acceptable. The values range 91 has the value zero as its lower limit and a first threshold value of 92 as its upper limit. In the graph in FIG. 6, the comparison parameter 90 is represented as a function of the decrease in the downscaling factor Df and thus the number of iterations of the calculation cycle 6. On lowering the downscaling factor Df, the comparison parameter 90 is initially zero or close to the value zero. When the downscaling factor Df falls below a second threshold value 93, the value of the comparison parameter 90 exceeds the first threshold value 92, leaving the previously defined range 91. Attaining such a condition indicates that the upscaled signal 13 differs excessively from the initial signal 11, and therefore that iteration of the calculation cycle 6 must be terminated. Consequently, if the comparison parameter 90 is outside the previously defined range 91, the comparison step 30 is followed by a subsequent step 40 of encoding an encoded signal 14 as a function of the downscaled signal 12.

During encoding step 40, the encoded signal 14 is created by recording the downscaled signal 12 calculated in the penultimate iteration of the calculation cycle 6 that is, in the iteration preceding that in which the comparison parameter 90 was found to be outside the previously defined range 91. Together with the downscaled signal 12, the upscaling factor Uf, calculated during the penultimate execution of step 60, is also recorded in the encoded signal 14.

According to a different embodiment of method 1, during encoding step 40 the encoded signal 14 is created by recording the downscaled signal 12 calculated in the penultimate iteration of the calculation cycle 6, together with the downscaling factor Df used in the penultimate execution of downscaling step 10.

According to another embodiment of method 1, during encoding step 40 the encoded signal 14 is created by recording the downscaled signal 12 calculated in the penultimate iteration of the calculation cycle 6, together with both the downscaling and upscaling factors Df, Uf used during the penultimate execution of the calculation cycle 6.

According to another embodiment of method 1, during the encoding step 40, the rescaling algorithm used in the downscaling step 10 and/or in the upscaling step 20 is also recorded in the encoded signal 40.

In all cases, the encoded signal 40 comprises all the data necessary for its own decoding.

With reference to FIG. 2, during an implementation of method 1, an initial image 121 is downscaled in the downscaling step 10, to obtain a first downscaled image 122a using a first downscaling factor Df=8.9%. During the upscaling step 20, a first upscaled image 123a is obtained with an upscaling factor Uf=1/Df=1123.5%. The first upscaled image 123a, in the subsequent comparison step 30, is identified as similar to the initial image 122, the comparison parameter 90 being within the range 91. In consequence, the method 1 continues with execution of the step 50 in which the downscaling factor Df is reduced to the value 0.2% and repetition of the calculation cycle 6. During the successive execution of the downscaling and upscaling steps 10, 20 are obtained, respectively, a second downscaled image 122b and a second upscaled image 123b. During the subsequent execution of the control step 30, the second upscaled image 123b is identified as being excessively different from the initial image 121, in that the comparison parameter 90 is outside the range 91. The method 1 continues with execution of the encoding step 40, in which an encoded image is created by recording the first downscaled image 122a together with the scaling factor Uf=1123.5%, the reciprocal of the first downscaling factor Df=8.9%.

In a different embodiment of the present invention, in a first execution of the calculation cycle 6 the value of the downscaling factor Df in % was set to:

Df=(1−ΔDf/100)*100,

wherein ΔDf is a preset value of the percentage decrease in the downscaling factor Df. For example, the value of ΔDf is set to 1%.

If, in the first execution of the calculation cycle 6, the value of the comparison parameter 90 is greater than the first threshold value 92, exceeding the limits of the previously defined range 91, iteration of the calculation cycle 6 is terminated and in the encoding step 40 the encoded signal 14 s created by recording a downscaled signal 12 equal to the initial signal 11. The values of Df and Uf recorded in the encoded signal 14 are both equal to 100%. On the other hand, if in the first execution of the calculation cycle 6, the value of the comparison parameter 90 does not exceed the first threshold value 92, but remains within the range 91, the calculation cycle 6 is executed a second time, assigning to the downscaling factor Df the value:

Df=(1−2*ΔDf/100)*100.

At the i^{th} iteration of the calculation cycle 6, the value of Df is equal to:

Df=(1−i*ΔDf/100)*100.

If, at the i^{th} iteration of the calculation cycle 6, the value of the comparison parameter 90 is greater than the first threshold value 92, exceeding the limits of the previously defined range 91, iteration of the calculation cycle 6 is terminated and the final value of Df, recorded in the encoded signal 14, is equal to:

Df=(1−(i−1)*ΔDf/100)*100.

In a different embodiment of the present invention, the value of Df is modified by passing from one iteration of the calculation cycle 6 to the next cycle by means of a dichotomy method. According to this variant, in a first execution of the calculation cycle 6, the value of the downscaling factor Df is set at 50%. If, in the first execution of the calculation cycle 6, the value of the comparison parameter 90 does not exceed the first threshold value 92, remaining within the range 91, the calculation cycle 6 is performed a second time, assigning the value 25% to the downscaling factor Df. At the i^{th} iteration of the calculation cycle 6, the value of Df is equal to half the Df value used in the (i−1)^{th} iteration of the calculation cycle 6. Again in this case, iteration of the calculation cycle 6 is terminated when the value of the comparison parameter 90 exceeds the first threshold value 92.

The method 1 comprises the further step 70 of decoding the encoded signal 14 to obtain a decoded signal 15 having the same dimensions as the initial signal 11.

The decoding step 70 comprises a first sub-step 71 of reading of the encoded signal 14, in particular of the downscaled signal 12 and of the upscaling factor Uf recorded therein. Following the first substep 71, the decoding step 70 comprises a second sub-step 72 analogous to the upscaling step 20, wherein the decoded signal 15 is generated by upscaling the downscaled signal 12 contained within the encoded signal 14, in accordance with the upscaling factor Uf obtained from the encoded signal 14.

With reference to the example in FIG. 2, the decoding step 70 enables a decoded two-dimensional image to be obtained which is identical to the upscaled image 123a.

The present invention provides a signal processing device comprising a memory in which are stored software encoding instructions adapted to execute the steps of method 1, when said instructions are carried out in the above-mentioned device. In particular, in respective variant embodiments of the present invention, the device produced according to the present invention consists of a digital photographic apparatus 100 or of a digital video apparatus (not represented) or of a computer (not represented) in which are stored the software encoding instructions adapted to execute the steps of method 1.

The present invention allows a method for processing images by means of rescaling to be integrated into the apparatus of the above-mentioned type, which method is characterised by good cost-effectiveness and efficiency in the managing of the dimensions of the signal and thus of the memory used for recording it. The technical solutions described enable the task and the aims, predetermined with reference to the cited known art, to be achieved in full.

1. A method of signal processing through rescaling, comprising the steps of:
downscaling an initial signal according to a predetermined downscaling factor for obtaining a downscaled signal,
upscaling said downscaled signal for obtaining an upscaled signal having the same dimensions as said initial signal,
comparing said initial signal with said upscaled signal for calculating a comparison parameter,
if said comparison parameter is within a predetermined range, decreasing (50) said downscaling factor and repeating said steps of downscaling, upscaling and comparing,
if said comparison parameter is outside said predetermined range, encoding an encoded signal based on said downscaled signal,

2. A method of signal processing according to claim 1, wherein said method further comprises the step of calculating an upscaling factor as a function of said downscaling factor, so that said upscaling factor is usable in said upscaling step for obtaining said upscaled signal from said downscaled signal.

3. A method of signal processing according to claim 1, wherein said step of encoding said encoded signal comprises recording a downscaled signal calculated in a previous execution of said downscaling step together with said downscaling factor and/or said upscaling factor.

4. A method of signal processing according to claim 2, wherein said step of encoding said encoded signal comprises recording a downscaled signal calculated in a previous execution of said downscaling step together with said downscaling factor and/or upscaling factor.

5. A method of signal processing according to claim 1, wherein a first scaling algorithm is used in said downscaling step and a second scaling algorithm is used in said upscaling step, said first and second algorithms being equal to or different from each other.

6. A method of signal processing according to claim 1, wherein said method comprises the further step of decoding said encoded signal for obtaining a decoded signal having the same dimensions as said initial signal.

7. A method of signal processing according to claim 1, wherein said initial signal, downscaled signal and upscaled signal and said decoded signal consist of an initial two-dimensional image, a downscaled two-dimensional image, an upscaled two-dimensional image and a decoded two-dimensional image, respectively, said downscaling factor being equal to the ratio of a number of pixels of said downscaled image with a number of pixels of said initial image, said upscaling factor being equal to the reciprocal of said downscaling factor.

8. A method of signal processing according to claim 1, wherein said initial signal, downscaled signal and upscaled signal and said decoded signal consist of respective video films.

9. A device for processing signals comprising a memory where software code instructions are stored for carrying out the steps of the method according to claim 1 when said instructions are carried out in said device for processing signals.

10. A device for processing signals according to claim 8, wherein said device is a digital photographic apparatus or a digital video apparatus.

11. A computer program directly loadable to a computer memory, said program comprising software code portions for carrying out the steps of the method according to claim 1 when said program is executed in said computer.
